(19) United States
(12) Patent Application Publication
(10) Pub. No.: US 2011/0085362 A1
(43) Pub. Date: Apr. 14, 2011

(54) DRIVE UNIT, FOR INSTANCE FOR HALOGEN LAMPS, AND CORRESPONDING METHOD

(75) Inventor: Luca Bordin, Shenzen (CN)

(73) Assignee: OSRAM GESELLSCHAFT MIT BESCHRAENKTER HAFTUNG, Muenchen (DE)

(21) Appl. No.: 12/996,979

(22) PCT Filed: Jun. 11, 2008
(86) PCT No.: PCT/IB2008/001550

§ 371 Date: Dec. 9, 2010

(51) Int. Cl. H02M 7/217

(52) U.S. Cl. 363/127

(57) ABSTRACT

A drive unit for electrical loads is provided. The drive unit may include an insulating transformer having a secondary winding for an alternate current to flow therethrough, wherein said secondary winding of said insulating transformer is coupled to electronic switches in a synchronous rectifier arrangement, said electronic switches to be alternatively switched on and off as a function of a trigger signal to produce a rectified output signal from said alternate current flowing through said secondary winding, wherein the unit includes a sense inductance coupled via a set of conductive strips to the secondary winding of said insulating transformer to sense the zero crossings of said alternate current flowing through said secondary winding and generate therefrom said trigger signal for said synchronous rectifier arrangement.

### FIELD OF THE INVENTION

This disclosure relates to driver units for electrical loads.

This disclosure was devised with specific attention paid to its possible application to halogen lamps. Reference to this field of application is only by way of example and is not to be construed in a limiting sense of the scope of the disclosure.

### DESCRIPTION OF THE RELATED ART

Low-voltage halogen lamps are currently powered by means of voltage transformers, either magnetic or electronic. These two solutions differ in terms of costs (including “Bill Of Materials”) and with respect of their output waveforms, due to the different mechanisms underlying their operation.

In the case of magnetic transformers, the frequency of operation is the line (mains) frequency and the output voltage has the same frequency of the input.

In the case of electronic step down convertors, the input frequency is the line frequency, but the convertor may operate at a switching frequency in the range of tens of kHz and the output frequency is the switching frequency.

Selecting either of these solutions may be dictated by the type of electrical appliance (e.g. rails or small luminaires) to be supplied, because the filament of the lamp is insensitive to the frequency of the current flowing through it.

Electronic transformers exhibit certain advantages when compared to magnetic transformers: in addition to the reduced size and weight, the efficiency of the voltage conversion is generally higher (for instance 0.7-0.85 for magnetic transformers up to 250 W and 0.93-0.96 for an electronic transformer (ET)). An efficiency which is 15% higher in feeding a 150 W load means saving 1.125 MWh over a 50,000 h useful lifetime of a device, which roughly corresponds to 1.125 tons less of CO₂ released in the air.

A disadvantage of electronic transformers (which are essentially switch-mode power supplies) lies in that the power delivered to the load may depend on the length of the cables. In fact, the frequency of the output signal is high enough to lead to energy losses in the cables towards the load due to the imaginary (non-real) component of their impedance.

In general terms, the longer the cables, the smaller the voltage, and thus the active power, delivered to the load. In the case of lighting applications, this reduces the efficacy of the system in term of lumen per Watt and makes electronic transformers hardly eligible for applications involving cables longer than 2 meters, while lengths as long as 10 meters are currently targeted for some common appliances.

A way to palliate this disadvantage is reducing the output frequency to the line frequency, or twice the line frequency, by means of either synchronous or so-called diode rectification. The difference between the two lies in the types of electronic switches used: MOSFETs in the former case, while in the latter case Schottky diodes are used.

FIGS. 1 to 3 herein are exemplary of a number of conventional topologies based on the principles mentioned in the foregoing.

Throughout FIGS. 1 to 3, CET and the (passive) magnetic transformer T denotes a conventionally electronic transformer with a tapped secondary winding instead of a classical two windings used in such step-down transformers.

In the basic diode rectification topology shown in FIG. 1, rectification is ensured by two diodes D1, D2, while a low-pass LC (i.e. inductor/capacitor) filter filters out the high frequency components of the output current.

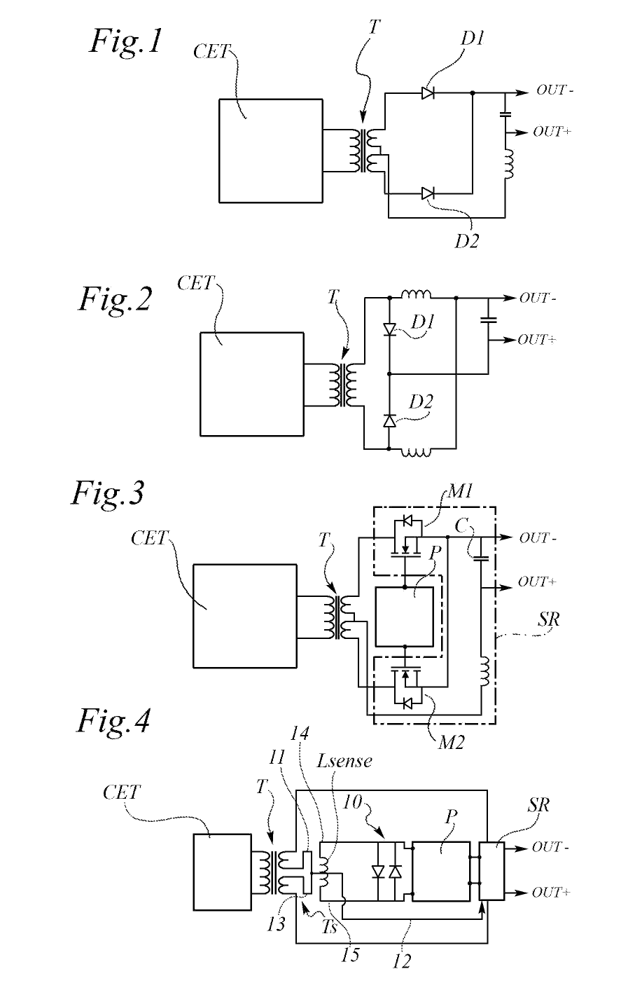

The arrangement of FIG. 2 is based on a current-doubler topology including again two diodes D1, D2 each having associated an inductor L while the output signal OUT+/OUT− is again taken across the terminals of an output capacitor C.

FIG. 3 is exemplary of an arrangement involving synchronous rectification. In that case, two electronic switches M1, M2 (typically MOSFETs) are coupled to the secondary winding of the insulating transformer T in a synchronous rectifier (SR) arrangement. A driver P ensures alternate on/off switching of the two switches M1, M2 (i.e. one switch “on” when the other is “off” and vice-versa) to produce a rectified signal. This is then fed to a low-pass LC filter to provide again an output signal across an output capacitor C.

As indicated, the topologies shown in FIGS. 1 to 3 are well known in the art, thus making it unnecessary to provide a more detailed description herein.

Arrangements involving Schottky diodes may require several diodes in parallel, which results in arrangements that are space consuming and not cost-effective. Both circuit complexity and power handling capability are higher in the case of “synchronous” rectification (FIG. 3) than in the case of “passive” arrangements as shown in FIGS. 1 and 2. Synchronous rectification is thus preferable for all those applications where the current required for the load is relatively high (for instance electronic transformers with medium-high power capabilities or “wattages”). In fact, many solutions are available on the market including integrated drivers—both analogue and digital-oriented—wherein the driver is triggered by the voltage signal to be rectified.

A topology as shown in FIG. 3 is however hardly acceptable for driving halogen lamps, where arrangements that are as cheap as possible are highly desired.

Flexibility in adapting the signals provided to the switches to the load conditions is another appreciated feature.

In fact, a synchronous rectifier arrangement relies on the timing of the driving signal to be provided to the switched therein (see for instance the MOSFETs M1 and M2 of FIG. 3).

In order to provide optimum operation, switching on and off of the switches should take place when the switches are not carrying the full current.

An approach is to force the transitions to take place when half the full current is flowing on one branch and the other half on the other so as to minimize power consumption.

The inventor has noted that with a voltage-driven arrangement this result may not be easy to achieve with possibly variable loads, namely with different cable lengths and/or different lamp “wattages”.

This is because the phase shift between the output voltage and current depends on these factors.

### OBJECT AND SUMMARY OF THE INVENTION

Having regard to the related art discussed in the foregoing, the need is still felt for drive units which, especially in consumer applications (e.g. halogen lamps) where cost represents a critical factor, may give rise to simple, yet effective arrangements adapted to be manufactured with a simple process, while ensuring full reliability and safety of the circuit.

The object of the invention is to provide such a drive unit.

According to the invention, this object is achieved by means of a drive unit having the features set forth in the claims that follow. The invention also relates to a corresponding method.

The claims are an integral part of the disclosure of the invention provided herein.

An embodiment of the arrangement described herein is based on the concept of optimising the driving circuit for the switches of a synchronous rectifier by sensing the current flowing through the secondary winding of the insulation transformer and letting the synchronous rectifier circuit switch from one branch to the other (that is from one switch to the other) when the current on the secondary winding is closed to zero.

In an embodiment, such a current sensing action is performed by means of an inductor which reacts with the magnetic field generated by the current flowing through the secondary winding of the insulating transformer; such a sense inductor acts like the secondary winding of a current transformer whose primary is traversed by the current flowing through the secondary winding of the insulating transformer.

In an embodiment, two-driver (i.e. two-switch) stages may be managed by means of a small circuit made up of a bobbin and one or more sets of diodes in anti-parallel connection.

With no input signal but only power supply, the two driver stages would be both set at the “high” level, thus enabling the current to flow at start up in either one or the other branch of the SR. The bobbin is mainly a current sense producing at its pins a positive or negative voltage difference, which is “topped” by the anti-parallel diodes thus providing a squarewave-like drive signal to trigger the switches (e.g. MOSFETs) in the synchronous rectifier.

For instance, when a current is flowing at the secondary side of the transformer, the gate of alternatively one of the MOSFETs is kept at a high level so that corresponding switch is closed (i.e. conductive or “on”), while the gate of the other MOSFET is brought to a low level, so that the corresponding switch is open (i.e. non-conductive or “off”). The dead time is automatically set by the circuit, possibly including the leakage inductance of the insulating transformer.

The arrangement described herein thus avoids certain drawbacks inherent in e.g. fixing the delay between the zero crossings of both output voltage and current (which is not easily feasible because all input and output conditions of the device should be fixed) or other more complicated solutions based on the concept of setting the current timing (which may be too expensive for the final product).

This is done by locking the trigger of the transitions to the zero crossings of the current on the secondary winding of the insulating transformer T.

This arrangement is fully operative irrespective of the topology of the synchronous rectifier SR (e.g. current doubler or not).

The arrangement described herein is significantly cheaper and simpler to manufacture than current solutions known in the literature.

### BRIEF DESCRIPTION OF THE ANNEXED REPRESENTATIONS

The invention will now be described, by way of example only, with reference to the annexed figures of drawing, wherein:

FIGS. 1 to 3 have already been discussed in the foregoing,

FIGS. 4 to 6 are block diagrams of a number of possible embodiments of the arrangement described herein, and

FIGS. 7 to 9 show in detail certain details of a component as included in the arrangement shown in the block diagrams of FIGS. 4 to 6.

### DETAILED DESCRIPTION OF EXEMPLARY EMBODIMENTS

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

Certain basic building blocks of the various embodiments shown in FIGS. 4 to 6 are essentially the same of the arrangements already discussed with reference to FIGS. 1 to 3, namely:
a conventional electronic transformer CET, with highlighted its insulating transformer T having a primary winding connected to the rest of the electronic transformer CET and a secondary winding coupled with switches (such as M1 and M2 of FIG. 3) in a synchronous rectifier arrangement to provide an output signal OUT+/OUT−, and
a driver P to provides trigger signals for the switches of the synchronous rectifier arrangement.

For the ease of representation, the secondary winding of the insulating transformer T is illustrated as separated from the block labelled SR where the switches M1 and M2 are located. In current embodiments, the secondary winding is in fact a part of the synchronous rectifier arrangement which provides the output signal. In any case, the elements considered in the foregoing may be any element/component known in the art for performing the corresponding function, which makes it unnecessary to provide a more detailed description herein. This description will rather focus on the arrangement used to derive from the insulating transformer T a squarewave-like signal to be applied to the driver P in order to enable the driver to properly trigger the switches of the synchronous rectifier SR.

Throughout FIGS. 4 to 6, Ts denotes a sensing transformer associated with the secondary winding of the insulating transformer T.

In the exemplary embodiment described herein the sensing transformer Ts includes:
a set of conductive strips (11-13 in FIG. 8) that define a primary winding of the sense transformer Ts through which the current of the secondary winding of the insulating transformer T flows, and
a sense inductor Lsense that is coupled to the consecutive strips 11-13 to constitute the secondary winding of the sense transformer Ts.

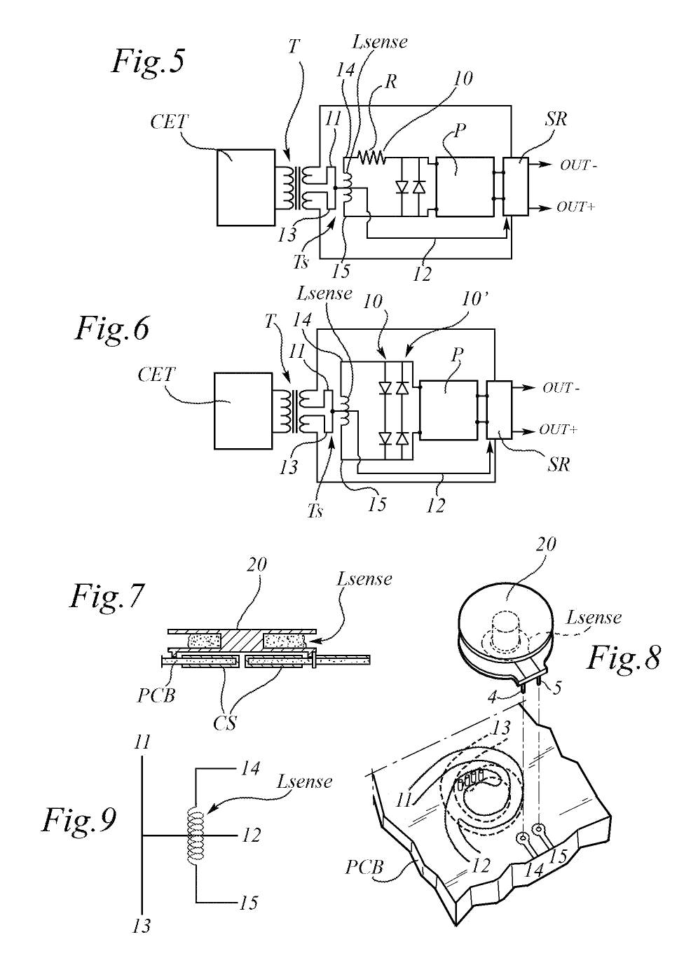

The voltage across the sense inductor Lsense is fed (in case via a resistor R, as shown in FIG. 5) to one (FIGS. 4 and 5) or two (FIG. 6) sets comprised of pairs of anti-parallel diodes.

The voltage across the set or sets of diodes 10, 10′ constitutes the signal fed to the driver P to trigger operation of the synchronous rectifier SR.

FIGS. 7 to 9 detail an exemplary embodiment of the sense transformer Ts where the transformer Ts is mounted on a printed circuit board (PCB) onto which the other elements of the drive unit are mounted. It will thus be appreciated that in such an embodiment the sense transformer Ts is not mounted on the insulating transformer T, and is thus provided at a location separate from the insulating transformer T.

In FIGS. 7 and 8 reference 20 denotes a coil-former (for instance a circular/toroidal coil former of a plastics material) onto which the windings of the sense inductor Lsense are wound to form the secondary winding of the sense transformer Ts.

The sense inductor Lsense may thus be constructed in the form of a small, self-contained component easily adapted to be soldered unto the printed circuit board PCB by connecting the ends 4, 5 of the winding wound on the coil former 20 to a respective conductive strips (copper tracks) 14, 15 provided on the PCB.

The conductive lines or strips (e.g. copper tracks) 11, 12 and 13 are provided on the PCB at a location such that, when the coil former 20 is mounted on the PCB itself, the windings 11 to 13 and the windings on the coil former 20 comprise the primary and secondary windings of the sense transformer Ts

FIG. 7 is generally representative of the possibility of locating the coil former 20 onto which the windings of the sense inductor Lsense are wound in close proximity of conductive strips CS provided on the PCB.

FIG. 9 details an example of electrical connections for the sense transformer Ts.

Specifically, references 11 and 13 denote the windings that are connected to the secondary winding of the insulating transformer T and which in turn identify the primary winding proper of the sense transformer Ts.

The line indicated by the reference numeral 12 is connected to the choke of the LC filter at the output of the drive unit (see for instance the connection shown in FIG. 3) while references 14 and 15 denote the terminals of the sense inductor Lsense.

The exemplary embodiment illustrated gives rise to a sense transformer Ts which is core-less and thus not saturable. This is helpful in two ways: on one hand the IN-OUT linearity is easily guaranteed (unlike the case where the primary current would flow in an hypothetical two winding Ts with magnetic core. This current would be remarkably high, thus leading to a fairly big core selection in order to ensure a proper signal at secondary side); on the other hand this solution is certainly cheaper.

In an embodiment, such a transformer includes e.g. 300 windings of thin wire on a plastic coil former 20 to produce a sense inductor (secondary winding of the sense transformer) adapted to sense the magnetic field produced by a couple of windings provided on the printed circuit board by means of the conductive strips 11 and 13 (primary winding of the sense transformer). The intensity and frequency of the current sense are sufficient to render this solution fully satisfactory.

Soldering problems are reduced to a very minimum because the current on the secondary winding is very low; the wire of the winding is thin and easy to be fixed to the pins of the coil former 20 to be then soldered (or otherwise connected) to corresponding conductive strips (copper tracks) on the printed circuit board (PCB).

In the exemplary embodiment illustrated, the primary winding of the sense transformer Ts is simply comprised of a set of conductive strips on the printed circuit board, thus avoiding any soldering problems or the need of providing any sort of winding on the insulating transformer.

Saturation problems are avoided since no core is present in the sense transformer Ts, which also avoids possible critical issues related to reproducibility during the current manufacturing process. The high turn ratio of the sensing transformer Ts avoids any effect on the primary side of any non linear load present at the secondary winding.

Closing the loop of the sense transformer Ts with anti-parallel diodes gives rise to a squarewave-like signal with pretty sharp edges which is fully adapted to be fed to the driver P. While a pair of anti-parallel diodes represents a fully satisfactory embodiment, other embodiments may include one pair of diodes plus a resistor R such as shown in FIG. 5 or two pairs of anti-parallel diodes.

Other embodiments for closing the loop may be easily devised depending on the need of the driver circuit. Proper sinking of the part of the current which is induced in the secondary winding of the current transformer and is not exploited as the driver input may be a factor to take into account in selecting the components for closing the loop of the sense transformer Ts.

The embodiments illustrated demonstrate that one simple inductor Lsense and two diodes may be fully satisfactory in providing a well defined and synchronised square wave adapted to be used as a driving signal for the driver P of the synchronous rectifier SR.

The current flowing through the “choke” (i.e. the low-pass filter used to filter out high frequency components of the output current) will not be zero other than when the half bridge on the primary side is switched off. Dimming and no-load conditions are thus automatically well addressed.

While on/off switching processes dramatically increase power consumption if transitions do not take place when the current intensity is half the way to zero at turn off to the full value at turn on, the arrangement described safely avoids this drawback by using a sense inductor which detects the zero crossings of the current in the secondary winding of the insulating transformer T with a non-saturable inductance that generates a signal sufficiently sharp and precise to be fed as an input trigger signal to the driver.

The arrangement described herein has very small requirements in terms of PCB space and is additionally very cheap. Moreover, the arrangement described herein does not require any positioning on the insulating transformer (which would add to complexity and cost of the insulating component itself) while also avoiding the use of a sense transformer provided with a core, which would be complex and expensive.

Moreover, the arrangement described herein avoids any soldering problem likely to be risky for the integrity of the whole device (for instance because bad working of a component might lead to permanent damage of the whole unit).

Without prejudice to the underlying principles of the invention, the details and embodiments may vary, even significantly, with respect to what has been described herein by way of example only, without departing from the scope of the invention as defined by the claims that follow.

1. A drive unit for electrical loads, the drive unit comprising:
an insulating transformer having a secondary winding for an alternate current to flow therethrough, wherein said secondary winding of said insulating transformer is coupled to electronic switches in a synchronous rectifier arrangement, said electronic switches to be alternatively switched on and off as a function of a trigger signal to produce a rectified output signal from said alternate current flowing through said secondary winding,
wherein the unit includes a sense inductance coupled via a set of conductive strips to the secondary winding of said insulating transformer to sense the zero crossings of said alternate current flowing through said secondary winding and generate therefrom said trigger signal for said synchronous rectifier arrangement.

2. The unit of claim 1, further comprising:
a sense transformer including said sense inductance as the secondary winding of said sense transformer.

3. The unit of claim 2,
wherein said sense transformer is a coreless transformer.

4. The unit of claim 2,
wherein said sense transformer is provided at a location separate from said insulating transformer.

5. The unit of claim 2, further comprising:
a printed circuit board, wherein said sense transformer includes conductive strips provided on said printed circuit board for traversing by said alternate current flowing through said secondary winding of said insulating transformer.

6. The unit of claim 1, wherein said conductive strips include a line for connection to an output choke to filter out high-frequency components in said rectified output signal of said synchronous rectifier arrangement.

7. The unit of claim 1, further comprising:
a printed circuit board and a coil former mounted on said printed circuit board, said coil former having wound thereon said sense inductance.

8. The unit of claim 1,
wherein said sense inductor is included in a loop for generating said trigger signal, said loop including at least one pair of anti-parallel diodes
wherein said trigger signal is detected across said at least one pair of anti-parallel diodes.

9. The unit of claim 8, further comprising:
a resistor connected to said sense inductor to close said loop.

10. A method of driving an electrical load by means of an insulating transformer having a secondary winding for an alternate current to flow therethrough, the method comprising:
producing a rectified output signal by synchronously rectifying said alternate current flowing through said secondary winding by alternately switching on and off electronic switches as a function of a trigger signal, and
sensing the zero crossings of said alternate current flowing through said secondary winding via a sense inductance coupled with a set of conductive strips to the secondary winding of said insulating transformer and generating therefrom said trigger signal for said electronic switches.
